(19) United States
(12) Patent Application Publication
(10) Pub. No.: US 2026/0022601 A1
(43) Pub. Date: Jan. 22, 2026

(54) HINGE SYSTEM

(71) Applicant: Thor Tech, Inc., Elkhart, IN (US)

(72) Inventor: Anton Steigmiller, Ummendorf (DE)

(73) Assignee: Thor Tech, Inc., Elkhart, IN (US)

(21) Appl. No.: 19/265,138

(22) Filed: Jul. 10, 2025

(30) Foreign Application Priority Data
Jul. 22, 2024 (DE) 10 2024 120 708.6

(51) Int. Cl. E05D 5/02; E05D 1/02; E05D 7/04

(52) U.S. Cl. CPC E05D 5/02; E05D 1/02; E05D 7/0415; E05D 2007/0469; E05Y 2600/12; E05Y 2900/512

(57) ABSTRACT

A hinge system for pivotably coupling at least one layered composite panel to a counterpart. The hinge system comprising a hinge element having a first hinge leaf and a second hinge leaf and a base element which is configured to be mechanically coupled to the first hinge leaf of the hinge element by means of a first coupling device. The base element is configured to be arranged at least predominantly within a layer structure of the layered composite panel and the base element is configured to be mechanically coupled to the layered composite panel by means of a first fastening device and/or a second fastening device.

### CROSS-REFERENCE TO RELATED APPLICATIONS

This application claims priority to German application No. 10 2024 120 708.6 filed Jul. 22, 2024, the disclosure of which is hereby incorporated by reference in its entirety.

### FIELD

The present invention relates to a hinge system for pivotably coupling at least one layered composite panel to a counterpart.

### BACKGROUND

The demands made on lightweight construction in furniture construction for camping vehicles are constantly increasing. For this purpose, multi-layer panel materials, or composite panel or sandwich elements, are used, in which, for example, the top layers are made of veneer plywood and the middle layers have honeycomb structures or other very lightweight materials. A robust connection of such panel materials and in particular a robust connection of such panel materials with standard fittings can be increasingly challenging.

### SUMMARY

In particular, if the thickness of a veneer plywood top layer is less than 6 mm, standard fittings cannot be coupled to such multi-layer panel materials with sufficient robustness without additional strengthening measures. In addition, for example hinges that have an adjustment option may not be suitable for mounting on sandwich materials with thin top layers.

According to aspects of the invention, a hinge system and a base element according to the features of the independent claims are proposed. Advantageous embodiments are the subject-matter of the dependent claims and of the following description.

According to one aspect, a hinge system for pivotably coupling at least one layered composite panel to a counterpart is proposed, wherein the hinge system has a hinge element and a base element. The hinge element has a first hinge leaf and a second hinge leaf. The base element is designed to be mechanically coupled to the first hinge leaf of the hinge element by means of a first coupling device. In addition, the base element is designed to be arranged at least predominantly within a layer structure of the layered composite panel. The base element can furthermore be configured to be mechanically coupled to the layered composite panel by means of a first fastening device and/or second fastening device.

In particular, the hinge system can be configured to be mechanically coupled to the counterpart by means of a second coupling device, wherein preferably the second hinge leaf of the hinge element has a second coupling device in order to mechanically couple the hinge system to the counterpart.

The layered composite panel or sandwich panel can have a first and a second cover layer, corresponding to an upper and a lower cover layer, between which a core of the layered composite panel is arranged corresponding to a sandwich structure. The core can in turn have multiple layers. In particular, the core can comprise a material having a lower specific gravity than the corresponding cover layer in order to provide a layered composite panel with the lowest possible surface density.

The laminated composite panel and/or the counterpart can be a flat panel or can have a two-dimensional or three-dimensional structure. The counterpart can comprise a layered composite material and/or a homogeneous material. For example, the layered composite panel can have a cover layer having a thickness of less than 6 mm or, in particular, a thickness between 3 mm and 1 mm. The core or middle layer can have any thickness for coupling to the hinge system and in particular can have for example a thickness of 9 mm. The core can for example have a honeycomb structure to provide the lowest possible specific weight with high robustness. The cover layers can be applied to the thermoplastic honeycomb core by means of a thermal process. Typically, the counterpart can comprise part of a body of a piece of furniture. Alternatively or additionally, the counterpart can also comprise part of a layered composite panel.

Advantageously, the proposed hinge system can make it possible to use layered composite panels and/or sandwich panels, or elements thereof, for axially mounted furniture fronts such as doors and/or flaps, in order to reduce the weight of the objects manufactured therewith.

This hinge system can be configured to be made primarily of plastic and thus have a low weight.

According to one aspect, it is proposed that the first fastening device and/or the second fastening device are configured to form a non-positive connection with an edge of a recess of a first top layer of the layered composite panel in order to mechanically couple the base element to the layered composite panel.

Advantageously, the first fastening device and/or the second fastening device can be configured to be coupled to the first hinge leaf or to the counterpart by means of a screwed connection, in order in particular to be able to provide connection points to a furniture front and a body without an adhesive connection.

The hinge system can be used to provide standardized semi-finished products for furniture parts and/or to simplify the manufacturing process for furniture, particularly for vehicles in the leisure sector. The hinge system can be adapted to different material thicknesses of the laminated composite panel and/or the counterpart.

The first cover layer of the layered composite panel can be a cover layer of the layered composite panel that adjoins the hinge system or the first hinge leaf of the hinge element.

Alternatively or additionally, the first fastening device and/or the second fastening device can be configured to form a positive connection with the first cover layer of the layered composite panel by means of a first latching element and/or a second latching element in order to mechanically couple the base element to the layered composite panel.

Advantageously, the first fastening device can be configured by means of a first fixing screw to fix the first latching element in a latched position of the positive connection. Alternatively or additionally, the second fastening device can be configured by means of a second fixing screw to fix the second latching element in a latched position of the positive connection.

The positive connection can be configured to support the fastening device against an inner edge of the first cover layer. This is described in more detail below in the present description of the invention.

Alternatively or additionally, the first fastening device can be configured to form the non-positive connection in each case by means of the first fixing screw. Alternatively or additionally, the second fastening device can be configured to form the corresponding non-positive connection by means of the second fixing screw.

The first cover layer can have a cutout whose shape and dimensions are configured to correspond to an outer shape and outer dimensions of the first and/or second fastening device in order to form the positive connection.

The first and/or second fastening devices can be configured, by means of an expansion element, to form the non-positive connection with the cutout of the first cover layer. The expansion element can have a conical hole with a thread into which a fixing screw is screwed in order to form the non-positive connection with the cutout of the first cover layer.

According to one aspect, it is proposed that the first latching element of the first fastening device is configured by means of a first elastic element, and/or the second latching element of the second fastening device is configured by means of a second elastic element, to be introduced and/or pressed into the recess of the first cover layer. By means of the elastic element in each case, when the latching elements have passed an inner edge of the first cover layer and the latching elements have expanded and/or locked in below the first cover layer, the positive connection with an inner surface of the first cover layer can be formed by means of at least one outer shoulder of the corresponding latching element.

In particular by means of the first latching element and/or the second latching element and a base plate of the base element, the base element can be configured to be fixed in a positively fitting manner between the inner surface of the first cover layer and an inner surface of a second cover layer of the layered composite panel. For this purpose, a thickness of the base element can be adapted to the space between the first cover layer and the second cover layer of the layered composite panel in order to advantageously be able to arrange a base plate of the base element directly adjacent to the second cover layer of the layered composite panel.

According to a further aspect, the base element can have a first adjusting element and the first hinge leaf can have a second adjusting element. The first adjusting element can be configured to interact with the second adjusting element in order to adjust and/or fix a relative position of the first hinge leaf with respect to the base element.

Advantageously, through the interaction of the first adjusting element with the second adjusting element, for example a furniture front on a finished piece of furniture can be readjusted, for example by loosening a screwed connection of the base element to the first hinge leaf and operating the first adjusting element in order to change a relative position of the first hinge leaf with respect to the base element.

In other words, the base plate can be fixed in the layered composite panel or in the sandwich element by means of the first fastening device and/or the second fastening device. The base element, which is arranged at least predominantly within the layer structure of the layered composite panel, can be inserted in the layered composite panel in the manner of an inlay, wherein the hinge element can be coupled to the inlay.

According to one aspect, the first adjusting element can have a first eccentric bolt and can be configured to cooperate in particular with the second adjusting element of the first hinge leaf in such a way that, particularly advantageously by means of a rotation of the first eccentric bolt relative to the base element, to adjust the relative position of the first hinge leaf with respect to the base element, in particular in a direction perpendicular to an axis of rotation of the hinge element.

The second adjusting element can have a slot whose longer extension is aligned parallel to the axis of rotation of the hinge element. The first eccentric bolt can have a first pin configured to engage in the slot of the second adjusting element in order to adjust the relative position of the first hinge leaf or the hinge element relative to the base element.

The first eccentric bolt can advantageously have a resiliently mounted projection in order to determine a position of the first eccentric bolt, in particular by cooperation of the projection with a recess in a wall of a cavity of the first adjusting element, wherein in particular the cavity can be configured to receive the first eccentric bolt. Through this feature, the first eccentric bolt can be positioned and/or fixed in the cavity of the first adjusting element. This can result in the advantage that during pre-assembly of the hinge system, a position of the first eccentric bolt and thus a position of the hinge element relative to the base element is predetermined. This can improve in particular the process reliability of assembly.

In particular, the first hinge leaf can be manufactured in one piece with the second hinge leaf and with a film hinge. Particularly advantageously, the first hinge leaf can be resiliently coupled to the second hinge leaf by means of the film hinge in order to form an axial coupling of the first hinge leaf to the second hinge leaf.

Alternatively or additionally, the first hinge leaf and the second hinge leaf can be manufactured in multiple parts, and the hinge system can have a hinge joint and/or a film hinge for an axial coupling of the first hinge leaf to the second hinge leaf in order to form the axial coupling of the first hinge leaf to the second hinge leaf.

The film hinge and the first and second hinge leaves can comprise a tough and resilient plastic if the hinge element was manufactured in one piece using the tough and resilient plastic.

According to one aspect, it is proposed that the second hinge leaf has a third adjusting element which is configured to cooperate with a fourth adjusting element of the counterpart in order to determine a relative position of the second hinge leaf with respect to the counterpart.

Advantageously, the interaction of the third adjusting element with the fourth adjusting element allows a readjustment of a furniture front on a finished piece of furniture, in that a position of the hinge element relative to the counterpart can be adjusted when the second coupling device, which can have a screwed connection, is loosened and is firmly coupled again to the counterpart after the adjustment.

Advantageously, because the second coupling device has a screw connection, a coupling of a furniture front to a furniture body can be carried out without gluing.

The third adjusting element can advantageously have a second eccentric bolt and be configured to interact with the fourth adjusting element of the counterpart in such a way that, particularly advantageously by means of a rotation of the second eccentric bolt relative to the second hinge leaf, the relative position of the second hinge leaf with respect to the counterpart, in particular in a direction parallel to the axis of rotation of the hinge element, is adjustably fixed and/or positioned and/or set.

The base element can have a guide groove and the first hinge leaf can have a corresponding guide rib, wherein the guide groove and the corresponding guide rib are configured to cooperate to guide an adjustment of the relative position of the first hinge leaf with respect to the base element perpendicular to the axis of rotation of the hinge element. Additionally or alternatively, the hinge element can be pre-assembled on the base element through the interaction of the guide groove and the corresponding guide rib.

Advantageously, the interaction of the first adjusting element with the second adjusting element can be supported by a linear guide by means of the guide rib of the hinge element in the guide groove of the base element for adjusting a position of the hinge element relative to the base element.

Advantageously, the second eccentric bolt can have a resiliently mounted projection in order to determine a position of the second eccentric bolt, in particular by interaction of the projection with a recess in a rear side of a wall of the second hinge leaf

Advantageously, a zero position of the hinge element relative to the counterpart can be predefined, in particular for pre-assembly, by means of an interaction of the resiliently mounted projection of the second eccentric bolt with the recess in the rear side of the wall of the second hinge leaf. Furthermore, the second eccentric bolt can be held in the third adjusting element by means of the engagement of the resiliently mounted projection in the described recess.

In other words, the first eccentric bolt and/or second eccentric bolt can have a projection resiliently arranged on a base body of the first and/or second eccentric bolt in order to position and/or fix the first and/or second eccentric bolt.

According to a further aspect, it is proposed that the third adjusting element has a receiving device, or a receiving rib, in order to cooperate with a second pin of the second eccentric bolt and an underside of a cylindrical base body of the second eccentric bolt in order to guide the second eccentric bolt.

To accommodate the second eccentric bolt in the third adjusting element, a first pin of the second eccentric bolt can be placed in a receiving hole of the second coupling device.

The fourth adjusting element of the counterpart can advantageously have a slot recess, wherein the slot recess is configured to cooperate with a base body of the second eccentric bolt such that a rotation of the second eccentric bolt displaces the second hinge leaf relative to the counterpart in a direction perpendicular to the hinge axis.

In particular, the first eccentric bolt can be designed identically to the second eccentric bolt. Particularly advantageously, the first eccentric bolt and/or the second eccentric bolt can have a cylindrical base body and a first pin, wherein the first pin is arranged on an upper side of the cylindrical base body, and wherein a center line of the first pin is offset parallel to a center line of the cylindrical base body in order to form the eccentric bolt.

Alternatively or additionally, the first eccentric bolt and/or the second eccentric bolt have a second pin on an underside of the cylindrical base body, wherein a center line of the second pin is arranged and aligned corresponding to the center line of the first pin.

According to one aspect, it is proposed that the first hinge leaf has a first coupling latching element and/or a second coupling latching element, wherein in each case the coupling latching element is configured to cooperate accordingly with a first coupling recess of the base element and/or with a second coupling recess of the base element in order to mechanically couple the hinge element to the base element.

Advantageously, the hinge element can be easily fixed and/or pre-assembled by the interaction of each coupling latching element with the corresponding coupling recess, in particular for mounting the hinge element on the base element.

Advantageously, the first hinge leaf and/or the second hinge leaf can be configured to form a position of the axis of rotation of the hinge element parallel to a contact surface of the first hinge leaf and the second hinge leaf, in particular displaced in a direction perpendicular to the contact surface, in order to reduce a gap dimension of the closed hinge element.

The gap dimension can define a distance between the surface of the first cover layer of the layered composite panel and an edge of the counterpart in the assembled state of the hinge system.

In particular, the first hinge leaf and/or the second hinge leaf can be configured such that, in the mounted position of the hinge system, the position of the axis of rotation of the hinge element is arranged below the counterpart (the panel) in order to reduce a gap dimension of the closed hinge element.

A base element for a layered composite panel for coupling to a hinge element is proposed. The coupling element can have a first coupling device which is designed to mechanically couple the base element to a first hinge leaf of the hinge element. Furthermore, the coupling element can be configured to be arranged at least predominantly within a layer structure of the layered composite panel. Furthermore, the base element can be configured to be mechanically coupled to the layered composite panel by means of a first fastening device and/or a second fastening device. In addition, the base element can comprise a first adjusting element, wherein the first adjusting element is configured to cooperate with a second adjusting element of the first hinge leaf in order to determine a relative position of the first hinge leaf with respect to the base element. In particular, the base element described here can be designed corresponding to one of the above-described base elements of the hinge system described above.

### BRIEF DESCRIPTION OF THE DRAWINGS

In the following, the present invention is described in detail with reference to some embodiments and the attached drawings.

In the drawings:

FIG. 1A shows a front view of a hinge system;

FIG. 1B shows a rear view of a hinge system;

FIG. 2 shows a plan view of a base element;

FIG. 3A shows a top view of an eccentric bolt;

FIG. 3B shows a side view of an eccentric bolt;

FIG. 4 shows a plan view of an assembled base element with adjusting element;

FIG. 5 shows a bottom view of a hinge system;

FIG. 6 shows a plan view of a hinge element;

FIG. 7 shows a bottom view of a hinge element;

FIG. 8 shows a rear view of a hinge system;

FIG. 9 shows a lower rear view of a hinge element with a third adjusting element;

FIG. 10 shows an upper rear view of a hinge element with a third adjusting element;

FIG. 11 shows a plan view of a counterpart for a hinge system; and

FIG. 12 shows a side view of an assembled hinge system.

### DETAILED DESCRIPTION

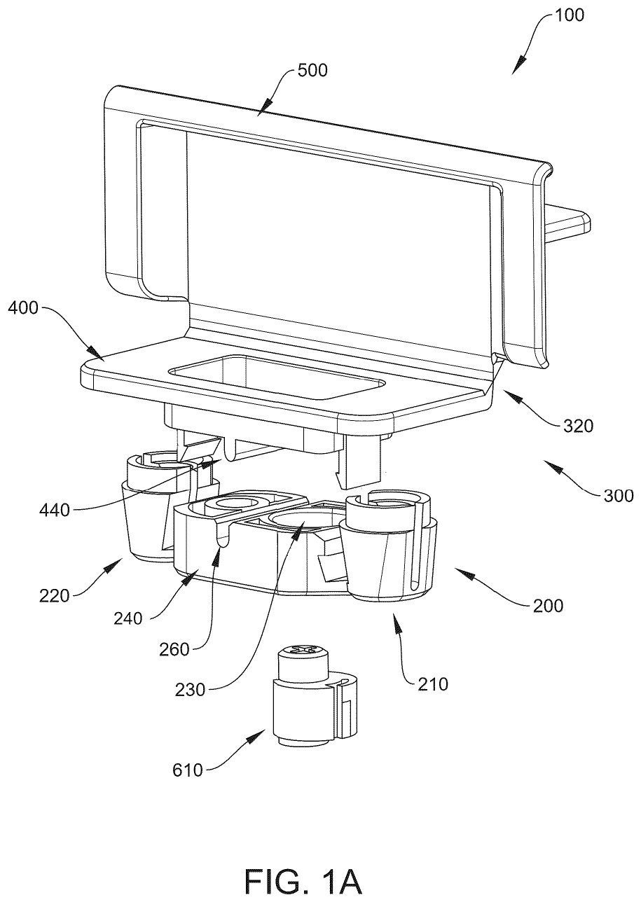

FIG. 1A schematically shows an isometric representation of a plan view of a front side of a hinge system 100 for pivotably coupling at least one layered composite panel 700 to a counterpart 800, wherein the hinge system 100 has a hinge element 300 and a base element 200. The hinge element 300 has a first hinge leaf 400 and a second hinge leaf 500, and the first hinge leaf 400 and the second hinge leaf 500 can be axially rotatably coupled to one another by means of a film hinge 320. The base element 200 is configured to be mechanically coupled to the first hinge leaf 400 of the hinge element by means of a first coupling device 240. Furthermore, the base element 200 is configured to be arranged at least predominantly within a layer structure of the layered composite panel 700 and can be configured to be mechanically coupled to the layered composite panel 700 by means of a first fastening device 210 and/or a second fastening device 220.

The base element 200 can have a first adjusting element, which can have a cavity 230 for receiving a first eccentric bolt 610. The first adjusting element can cooperate with a second adjusting element, which is arranged in the first hinge leaf 400, in order to set and/or adjustably fix a relative position of the first hinge leaf 400 with respect to the base element 200, in particular in a direction perpendicular to an axis of rotation 320 of the hinge element 300.

The base element (200) can have a guide groove (260) and the first hinge leaf (400) can have a corresponding guide rib (440), wherein the guide groove (260) and the corresponding guide rib (440) are configured to cooperate to guide the adjustment of the relative position of the first hinge leaf (400) with respect to the base element (200) perpendicular to the axis of rotation of the hinge element (200).

FIG. 1B schematically shows an isometric representation of a rear view of the hinge system 100, in which a second coupling device 520 of the hinge system 100 is schematically shown. The hinge system 100 can be configured to be mechanically coupled to the counterpart 800 by means of the second coupling device 520. For this purpose, the second hinge leaf 500 of the hinge element 300 can have the second coupling device 520, which can be mechanically coupled to a rear surface of the second hinge leaf 500 by means of a first web 527 and a second web 528 to the rear surface of the second hinge leaf 500. A first slot 522 and a second slot 526 in the second coupling device 520 can be configured to mechanically couple the second hinge leaf 500 to the counterpart (800) by means of a screwed connection in each case in order to mechanically couple the hinge system (100) to the counterpart 700. The rear surface of the second hinge leaf 500 can be defined in that it lies opposite a contact surface of the first hinge leaf 400 with the second hinge leaf 500 when the hinge element 300 is closed.

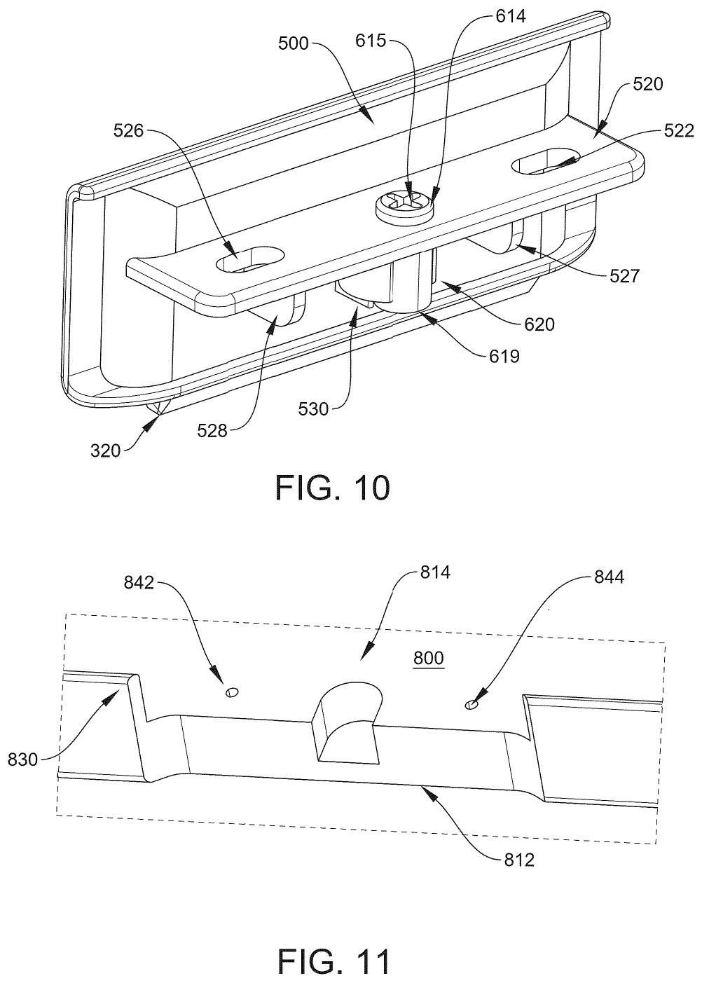

The second hinge leaf 500 can have a third adjusting element which is configured to cooperate with a fourth adjusting element 814 of the counterpart 800 (FIG. 11) in order to determine a relative position of the second hinge leaf 500 with respect to the counterpart 800. For this purpose, the third adjusting element can be configured to receive a second eccentric bolt 620 by means of a receiving hole 524 in the second coupling element 520 and a receiving device 530 arranged on the rear side of the second hinge leaf 500. The third adjusting element can thus have the receiving hole 524, the receiving device 530 and the second eccentric bolt 620.

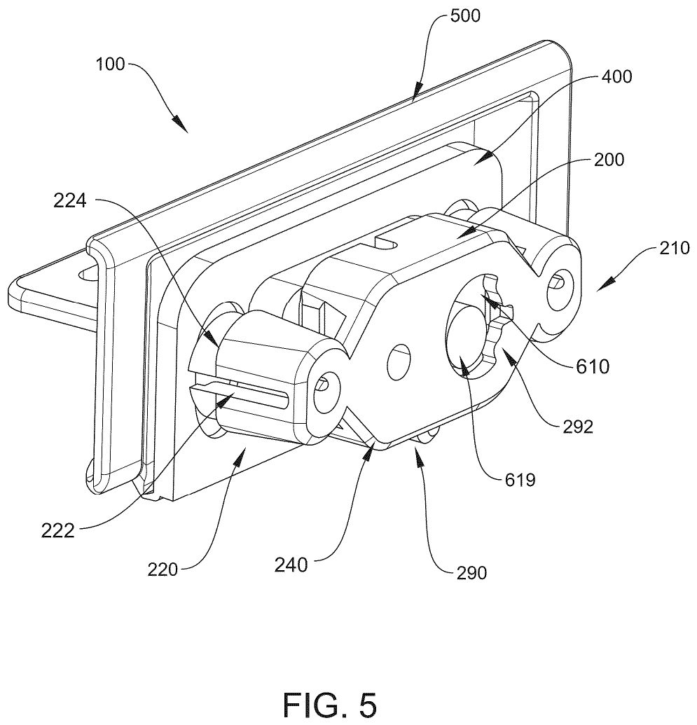

FIG. 6 schematically shows an isometric front plan view of the hinge element 300 with the first hinge leaf 400 and the second hinge leaf 500, which are rotatably coupled about a hinge axis by means of a film hinge 320, wherein the hinge element 300 is manufactured in one piece. A second adjusting element has a slot in the first hinge leaf 400 in order to cooperate with a first pin 614 of the first eccentric bolt 610 of the first adjusting element to adjust and/or fix a relative position of the first hinge leaf 400 with respect to the base element 200. For this purpose, the slot 420 can extend parallel to the axis of rotation of the hinge element 300. A hole 410 in the first hinge leaf 400 is configured to cooperate with the first coupling device of the base element 200 in order to couple the hinge element 300 to the base element 200.

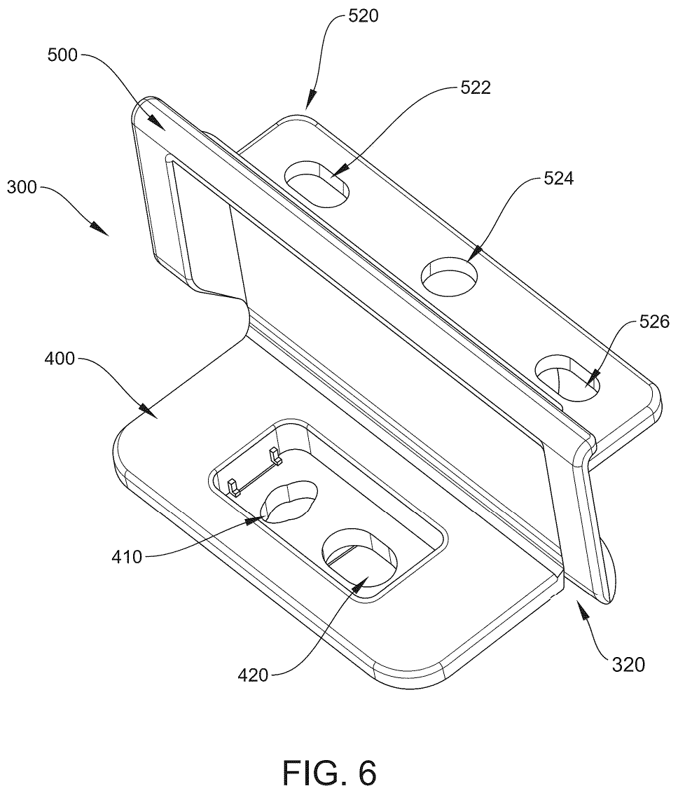

FIG. 7 schematically shows an isometric front bottom view of the hinge element 300. A guide rib 440, which is coupled to the first hinge leaf 400 at an underside, can be configured to cooperate with the guide groove 260 of the coupling element 200 in order to guide the adjustment of the relative position of the first hinge leaf 400 with respect to the base element 200, in particular perpendicular to the axis of rotation of the hinge element 200. In addition, the first hinge leaf can have on its underside a first coupling latching element 432 and/or a second coupling latching element 434, which are configured to cooperate with a first coupling recess 218 of the base element 200 and/or correspondingly with a second coupling recess 228 of the base element 200 in order to mechanically couple the hinge element 300 to the base element 200.

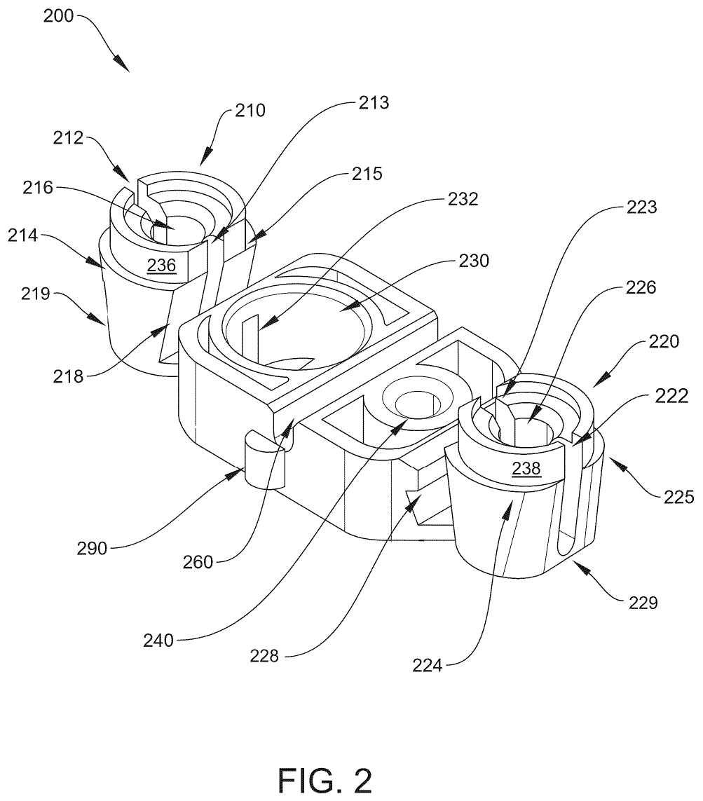

FIG. 3A schematically shows an isometric representation of a front view of the first eccentric bolt 610, which can be designed identically to the second eccentric bolt 620. The first eccentric bolt 610 and/or the second eccentric bolt 620 have a cylindrical base body 612 and a first pin 614, wherein the first pin 614 is arranged on an upper side of the cylindrical base body. A center line of the first pin 614 can be offset parallel to a center line of the cylindrical base body 612 to form the eccentric pin in each case. In addition, the first eccentric bolt 610 and/or the second eccentric bolt 620 can have a resilient element 616 on an outer cylindrical surface of the corresponding base body 612, which resilient element is configured to spring perpendicular to the outer cylinder surface of the base body 612. The resilient element 616 is mechanically coupled to a projection 618 which projects beyond the outer cylinder surface of the base body 612 in order to engage by means of the projection 618 in a recess 232 in a wall of the cavity 230 of the first adjusting element of the base element 200 and/or in a recess 532 in a rear wall of the second hinge leaf 500, in particular in order to position and/or fix the first and/or second eccentric bolts 610, 620. Furthermore, the first pin 614 of the first and/or second eccentric bolts 610, 620 can have a device 615 which is configured to receive a tool in order to rotate the first and/or second eccentric bolts 610, 620 in particular about a central axis of the first pin 614.

FIG. 3B schematically shows an isometric side view of the first and/or second eccentric bolts 610, 620, with a second pin 619 arranged on an underside of the cylindrical base body 612, wherein a center line of the second pin 619 is arranged and aligned according to the center line of the first pin 614, in particular such that the center line of the first and second pins 614, 619 can act according to an axis of rotation for the first and/or second eccentric bolt 610, 620.

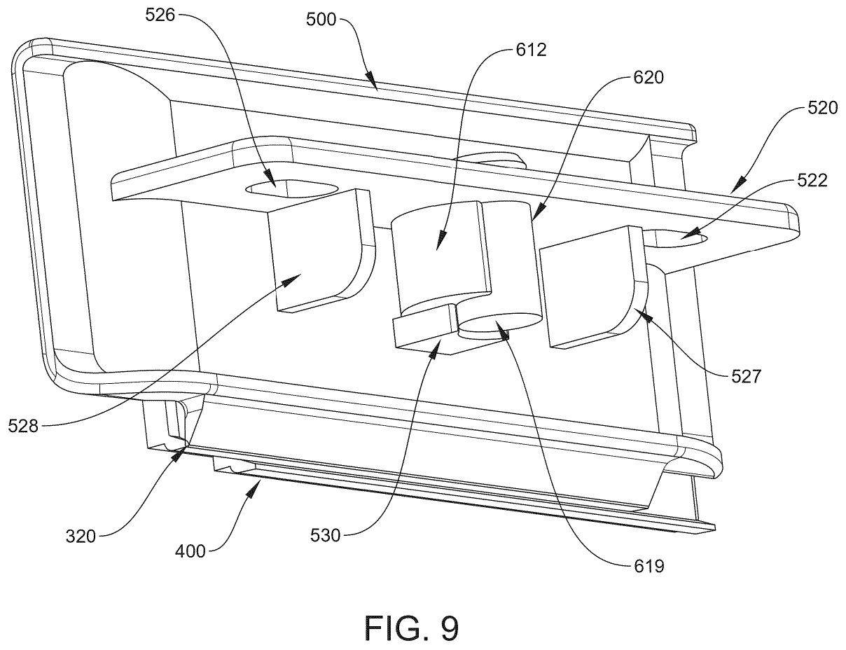

FIG. 10 schematically shows an isometric representation of a rear view of the second hinge leaf 500 to illustrate how a first pin 614 of the second eccentric bolt 620 is received by the receiving hole 524 and how a base body 612 of the second eccentric bolt 620 is supported by the receiving device 530. The first pin 614 can comprise the device 615 which is configured to receive the tool in order to rotate the eccentric bolt 610, 620.

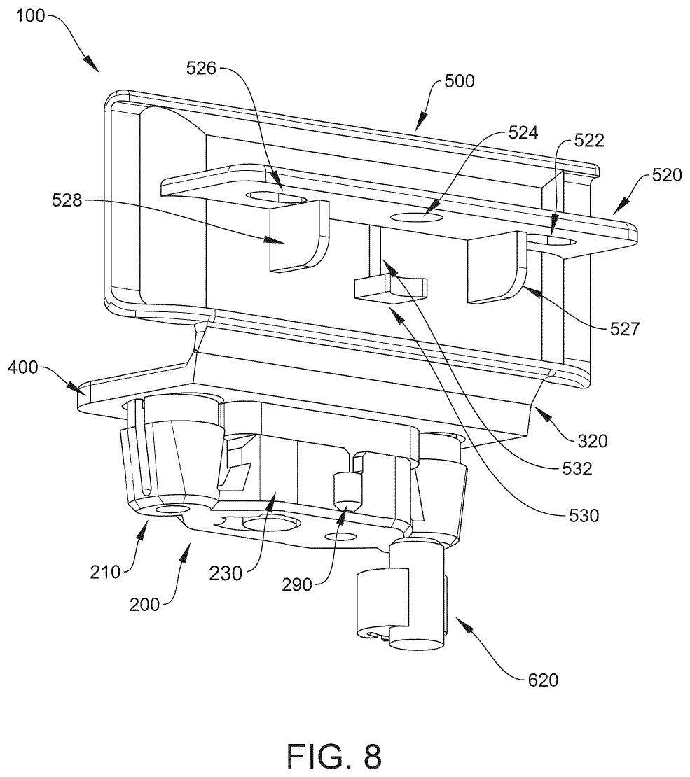

FIG. 9 schematically shows an isometric representation of a rear bottom view of the second hinge leaf 500 to illustrate how a second pin 619 of the second eccentric bolt 620 is guided by the receiving device 530 and how the base body 612 of the second eccentric bolt 620 is supported by the receiving device 530. The third adjusting element can be configured with the receiving device 530 to cooperate with the second pin 619 of the second eccentric bolt (620) and an underside of a cylindrical base body 612 of the second eccentric bolt 620 in order to guide the second eccentric bolt 620 in particular during a rotation of the second eccentric bolt 620.

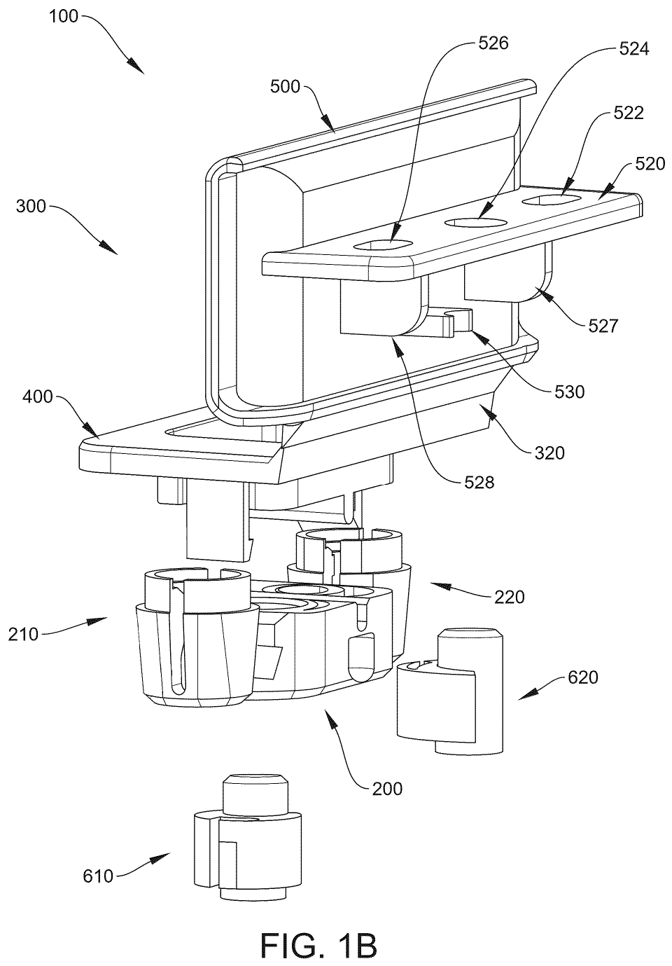

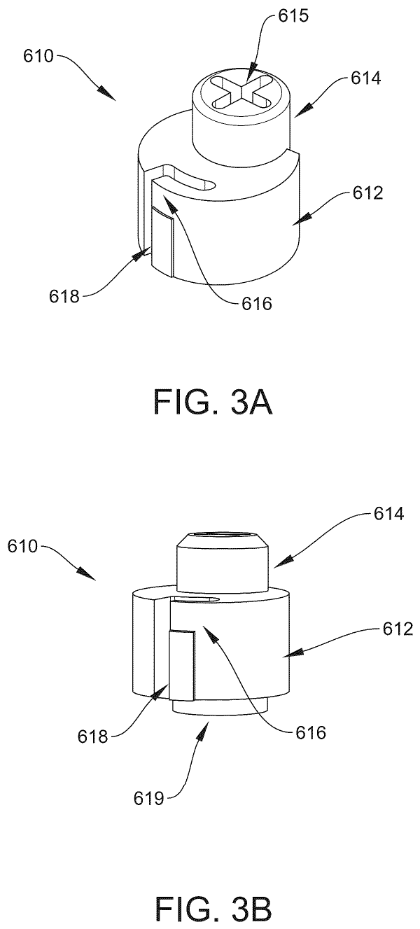

FIG. 2 schematically shows an isometric plan view of an upper side of the base element 200, wherein the upper side faces the first hinge leaf 400 in the assembled state of the hinge system. The base element 200 has a first fastening device 210 and a second fastening device 220, each of which is configured to form a non-positive connection with an edge of a recess (710, FIG. 4) of a first cover layer of the layered composite panel 700 in order to mechanically couple the base element to the layered composite panel 700.

For this purpose, the first fastening device 210 can have a first cylindrical outer collar 236 and/or the second fastening device 220 can have a second cylindrical outer collar 238. The first and/or second fastening devices 210, 220 can each have a first gap 212, 222 and a second gap 213, 223 along a central axis of the first and/or second fastening devices 210, 220 and aligned with a longitudinal direction of the base element 200. The central axis of the first and/or second fastening devices 210, 220 can extend along a receiving opening 216, 226 of the first and/or second fastening devices 210, 220, each of which is configured to receive a fixing screw.

The first gap 212, 222 and the second gap 213, 223 of each fastening device can extend from the top of the base element 200 to a bottom surface of the base element 200 in order to divide the first and/or the second fastening devices 210, 220 into two parts which are resiliently coupled by means of the corresponding bottom surface 219, 229 of the base element 200.

Due to the gaps 212, 222 and 213, 223 of the fastening devices 210, 220, the first and/or the second cylindrical outer collars 236, 238 can each be divided into two collar parts, which, in the assembled state of the base element 200 in the layered composite panel 700, can be arranged in a positively fitting manner on the corresponding recess 710 of the first cover layer.

Furthermore, the first and/or second fastening devices 210, 220 can be configured by means of a corresponding first and/or second fixing screw 724, 722 to fix the positive connection of the first and/or second collar parts of the outer collar 236, 238, and, in particular by means of a conical taper of the receiving opening 216, 226 for the first and/or second fixing screw 724, 722, to couple the collar parts of each outer collar 236, 238 in a non-positive manner to the recess 710 of the first cover layer of the layered composite panel 700, in order to form in each case a non-positive connection of the first and/or second fastening devices 210, 220 to the first cover layer of the layered composite panel 700.

Alternatively or additionally, the first and/or second fastening devices 210, 220 can be configured by means of a first latching element 214, 215 and/or second latching element 224, 225 to form a positive connection with an inner surface of the first cover layer of the layered composite panel 700, in particular at an inner edge of the recess 710 of the inner surface of the first cover layer of the layered composite panel 700, in order to mechanically couple the base element 200 to the composite panel 700. For this purpose, the first latching element 214, 215 and/or the corresponding second latching element 224, 225 can have an outer shoulder which forms the positive connection of the first and/or second latching elements with the inner surface of the first cover layer. In this case, in each case a shoulder surface of the outer shoulder can be configured to be arranged directly adjacent to the inner surface of the first cover layer in the assembled state of the base element 200.

On the basis of the division in each case of the first and/or second fastening devices 210, 220, the first latching element 214, 215 and/or the second latching element 224, 225 can each have two latching element parts which are resiliently coupled by means of the corresponding bottom surface 219, 229. The latching element parts of the latching elements can be configured to be inserted into the recess 710 of the first cover layer of the layered composite panel 700 being pressed against one another, and to spread open again after passing the outer shoulders of the latching element part on the inner surface of the first cover layer, in particular to form the positive connection of the first and/or second latching elements with the inner surface of the first cover layer, and to advantageously mechanically couple the base element 200 to the layered composite panel 700.

The base element 200 can have a first coupling recess 218 and/or a second coupling recess 228, each of which is configured to cooperate with the first coupling latching element 432 and/or correspondingly with the second coupling latching element 434 of the first hinge leaf 400 in order to mechanically couple the hinge element 300 to the base element 200. For this purpose, the first and/or the second coupling recesses 218, 228 can have an undercut in which a corresponding latching lug of the first and/or second coupling latching element 432, 434 can engage.

The base element 200 can have a positioning protrusion 290 which can interact with a correspondingly shaped recess 710 of the first cover layer of the layered composite panel 700 in order to determine a defined installation position of the base element 200 in the layered composite panel 700.

FIG. 4 shows an isometric plan view of the surface of the base element 200, which is arranged at least predominantly within a recess 710 of a layer structure of the layered composite panel 700. The base element 200 is fixed or non-positively connected by means of the first and second fixing screws 722, 724, which are arranged in the corresponding receiving opening 216, 226 of the first and second fastening devices 210, 220. In this illustration, the first eccentric bolt 610 is arranged, in particular with the first pin 614 and the device 615 for receiving a tool, in the recess 710 of the base element 200 in order to form the first adjusting element. In particular, the device 615 for receiving a tool can have a Phillips-shaped recess for actuation by a Phillips screwdriver.

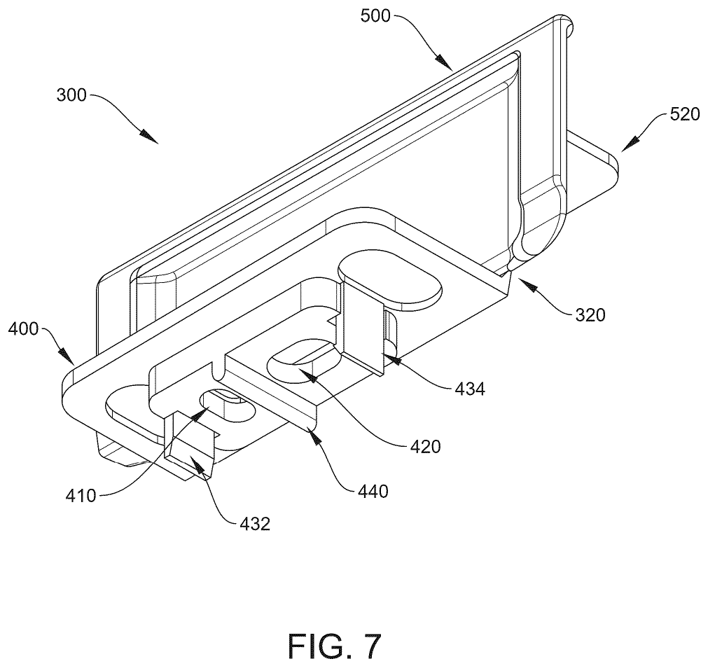

FIG. 8 schematically shows an isometric representation of a bottom view of a rear side of the hinge system 100, wherein, in addition to the previous explanations, a recess 532 is provided for engagement of the projection 618 of the second eccentric bolt 620, in particular in order to fix and/or lock the second eccentric bolt 620 in a zero position of the second eccentric bolt 620 during assembly of the hinge element 300.

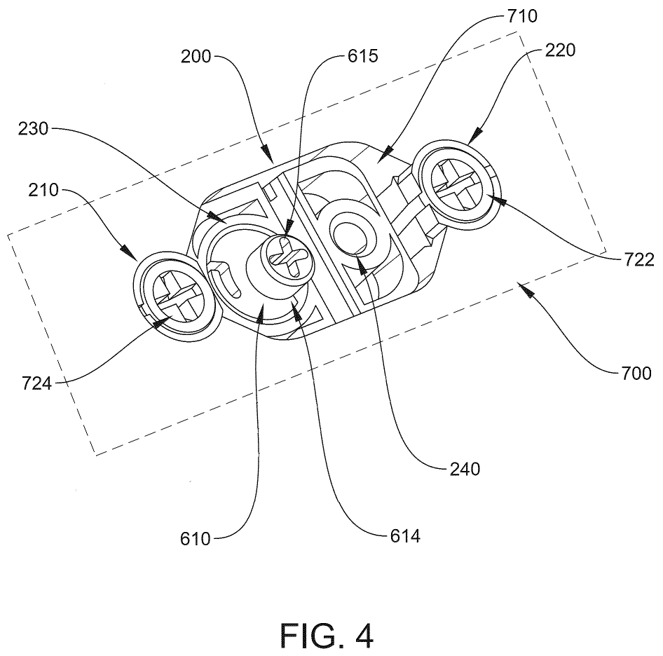

FIG. 5 schematically shows the hinge system 100 with an isometric representation of a plan view of an underside of the base element 200, wherein the first eccentric bolt 610 is arranged within the cavity 230 of the base element 200. Since a bottom of the base element 200 has an opening 292, the second pin 619 of the first eccentric bolt 610 can be received by the base element 200. As a result, the first eccentric bolt 610 can be designed identically to the second eccentric bolt 620.

FIG. 11 schematically shows, in an isometric view, an embodiment of a connection of the counterpart 800 to the second hinge leaf 500 for coupling the hinge system 100 to the counterpart 800. The counterpart 800 is configured to be coupled to the hinge element 300 by means of a first hole 842 and a second hole 844, and by means of a screwed connection with the first slot 522 and the second slot 526 in the second coupling device 520 of the second hinge leaf 500. The counterpart 800 can have a fourth adjusting element 814, which is configured in the form of a slot recess to cooperate with the base body 612 of the second eccentric bolt 620 such that, in particular, a rotation of the second eccentric bolt 620 displaces the second hinge leaf 500 relative to the counterpart 800 in a direction perpendicular to the hinge axis in order to adjust and/or adjustably fix the second hinge leaf 500 relative to the counterpart 800. To accommodate the second hinge leaf 500, the counterpart 800 can have a recess 812. The counterpart 800 can have an edge 830 which is interrupted for receiving and/or coupling to the second hinge leaf 500.

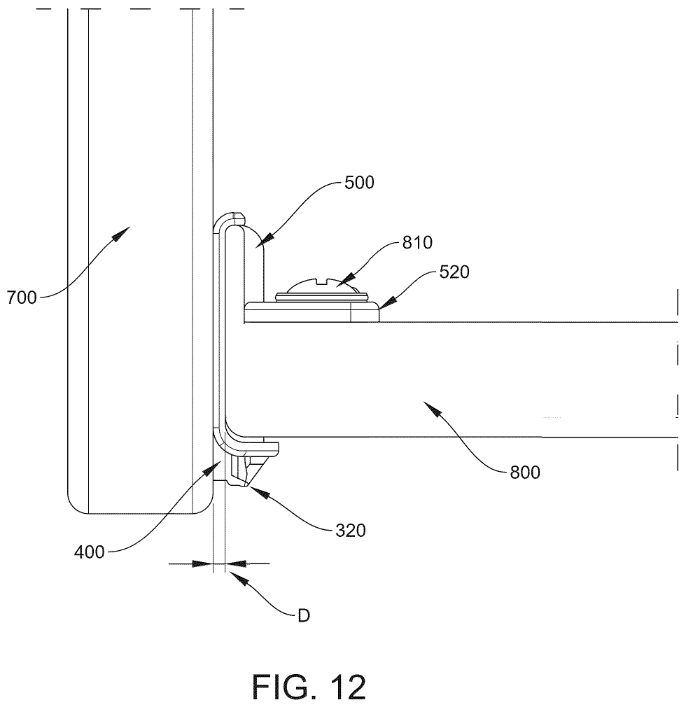

FIG. 12 schematically shows a side view of the assembled hinge system 100, wherein the hinge system 100 pivotably couples the layered composite panel 700 to the counterpart 800. The hinge element 300 is coupled to the counterpart 800 by means of the second coupling device 520 of the second hinge leaf 500 and by means of a screwed connection 810. The hinge element 300 is mechanically coupled to the layered composite panel 700 by means of the first hinge leaf 400 and the base element 200 (not shown here). The axial coupling 320 of the first hinge leaf 400 to the second hinge leaf 500 is designed such that in the assembled state of the hinge system 100 the axial coupling 320 is arranged with the layered composite panel 700 and the counterpart 800 below a bottom side of the counterpart 800, in particular parallel to a contact surface of the first hinge leaf 400 and the second hinge leaf 500 in a direction perpendicular to the contact surface, when the top side of the counterpart 800 is mechanically coupled to the second coupling device 520 of the second hinge leaf 500. This makes it possible to reduce or minimize a gap dimension D, which denotes a distance between a surface of the layered composite panel 700 and an edge of the counterpart 800.

When assembling the hinge system 100 with a layered composite panel 701 counterpart 800, in a first step a first eccentric bolt 610 can be inserted into a cavity 230 of a base element 200. Here the first eccentric bolt 610 can be rotated such that the resiliently mounted projection 618 of the first eccentric bolt 610 engages in a recess 232 of the wall of the cavity 230 of the coupling element 200 in order to position the first eccentric bolt 610 in a zero position in the base element 200. In a further step, the base element 200 together with the positioned first eccentric bolt 610 can be inserted into a recess 710 of the layered composite panel 700 and fixed by means of a first fixing screw 724 and by means of a second fixing screw 722 in a receiving opening 216 of the first fastening device or in a receiving opening 226 of the second fastening device in order to couple the coupling element 200 to the layered composite panel 700. In a further step, a hinge element 300 can be latched into a first and/or second coupling recess 218, 228 of the base element 200 by means of a first and/or second coupling latching element 432, 434 of a first hinge leaf 400 of the hinge element 300 and coupled to the base element 200 by means of a first coupling device 240, in particular by means of a screwed connection. In a further step, a second eccentric bolt 620 can be inserted into a receiving device 530 of a second hinge leaf 500 of the hinge element. In a further step, the second hinge leaf 500 of the hinge element 300, equipped with the second eccentric bolt 620, can be coupled to the counterpart 800, in particular by means of a screwed connection, in order to couple the layered composite panel or a furniture front to the counterpart 800 or a furniture body. The counterpart 800 can have a recess 812 in order to position the second hinge leaf 500 on the counterpart 800.

In the present description, identical reference symbols denote the same objects in order to largely avoid repetitions in the description when the same objects are repeatedly shown in different figures.

1. A hinge system for pivotably coupling at least one layered composite panel to a counterpart, comprising:
a hinge element having a first hinge leaf and a second hinge leaf; and
a base element which is configured to be mechanically coupled to the first hinge leaf of the hinge element by means of a first coupling device; and
wherein the base element is configured to be arranged at least predominantly within a layer structure of the layered composite panel; and
wherein the base element is configured to be mechanically coupled to the layered composite panel by means of a first fastening device and/or a second fastening device.

2. The hinge system according to claim 1,
wherein the first fastening device and/or the second fastening device are configured to form a non-positive connection with an edge of a recess of a first top layer of the layered composite panel in order to mechanically couple the base element to the layered composite panel; and/or
wherein the first fastening device and/or the second fastening device are configured to form a positive connection with the first cover layer of the layered composite panel by means of a first latching element and/or a second latching element in order to mechanically couple the base element to the layered composite panel.

3. The hinge system according to claim 2, wherein the first fastening device is configured by means of a first fixing screw to fix the first latching element in a latched position of the positive-fit connection, and/or is configured by means of a second fixing screw to fix the second latching element in a latched position of the positive-fit connection; and/or
the first fastening device is configured by means of the first fixing screw to form the non-positive connection; and/or the second fastening device is configured by means of the second fixing screw to form the non-positive connection.

4. The hinge system according to claim 2,
wherein the first latching element of the first fastening device is configured, by means of a first resilient element; and/or wherein the second latching element of the second fastening device is configured, by means of a second elastic element, to be introduced into the recess of the first cover layer in order to form the positive connection with an inner surface of the first cover layer in the latched position of the positive connection, by means of at least one outer shoulder of the first latching element or the second latching element.

5. The hinge system according to claim 1, wherein the base element has a first adjusting element; and the first hinge leaf has a second adjusting element, wherein the first adjusting element is configured to cooperate with the second adjusting element to adjust a relative position of the first hinge leaf with respect to the base element.

6. The hinge system according to claim 5, wherein the first adjusting element has a first eccentric bolt and is configured to cooperate the second adjusting element of the first hinge leaf in such a way that, a rotation of the first eccentric bolt relative to the base element, to adjust the relative position of the first hinge leaf with respect to the base element, in a direction perpendicular to an axis of rotation of the hinge element.

7. The hinge system according to claim 6, wherein the first eccentric bolt has a resiliently mounted projection in order to determine a position of the first eccentric bolt by cooperation of the projection with a recess in a wall of a cavity of the first adjusting element, wherein the cavity is configured to receive the first eccentric bolt.

8. The hinge system according to claim 1, wherein the first hinge leaf is manufactured in one piece with the second hinge leaf and with a film hinge; and the first hinge leaf is resiliently coupled to the second hinge leaf by means of the film hinge in order to form an axial coupling of the first hinge leaf with the second hinge leaf; and/or wherein
the first hinge leaf and the second hinge leaf are manufactured in multiple parts, and the hinge system has a hinge joint for an axial coupling of the first hinge leaf to the second hinge leaf in order to form the axial coupling of the first hinge leaf to the second hinge leaf.

9. The hinge system according to claim 1, wherein the second hinge leaf has a third adjusting element which is configured to cooperate with a fourth adjusting element of the counterpart in order to determine a relative position of the second hinge leaf with respect to the counterpart.

10. The hinge system according to claim 9, wherein the third adjusting element has a second eccentric bolt and is configured to cooperate with the fourth adjusting element of the counterpart in such a way that a rotation of the second eccentric bolt relative to the second hinge leaf, the relative position of the second hinge leaf with respect to the counterpart is adjustably fixed in a direction parallel to the axis of rotation of the hinge element.

11. The hinge system according to claim 10, wherein the third adjusting element has a receiving device to cooperate with a second pin of the second eccentric bolt and with an underside of a cylindrical base body of the second eccentric bolt in order to guide the second eccentric bolt.

12. The hinge system according to claim 10, wherein the fourth adjusting element of the counterpart has a slot recess, and wherein the slot recess is configured to cooperate with a base body of the second eccentric bolt such that a rotation of the second eccentric bolt displaces the second hinge leaf relative to the counterpart in a direction perpendicular to the hinge axis.

13. The hinge system according to claim 1, wherein the first hinge leaf has a first coupling latching element and/or a second coupling latching element, wherein in each case the coupling latching element is configured to cooperate accordingly with a first coupling recess of the base element and/or with a second coupling recess of the base element in order to mechanically couple the hinge element to the base element.

14. The hinge system according to claim 1, wherein the first hinge leaf and/or the second hinge leaf are configured to form a position of the axis of rotation of the hinge element parallel to a contact surface of the first hinge leaf and of the second hinge leaf, and displaced in a direction perpendicular to the contact surface, in order to reduce a gap dimension of the closed hinge element.

15. A base element for a layered composite panel for coupling to a hinge element, comprising:
a first coupling device that is configured to mechanically couple the base element to a first hinge leaf of the hinge element;
wherein the base element is configured to be arranged at least predominantly within a layer structure of the layered composite panel; and
wherein the base element is configured to be mechanically coupled to the layered composite panel by means of a first fastening device and/or a second fastening device; and
wherein the base element has a first adjusting element; and
wherein the first adjusting element is configured to cooperate with a second adjusting element of the first hinge leaf in order to determine a relative position of the first hinge leaf with respect to the base element.
